(19) United States
(12) Patent Application Publication
(10) Pub. No.: US 2024/0253248 A1
(43) Pub. Date: Aug. 1, 2024

(54) GRIPPING DEVICE, ROBOT AND METHOD FOR SENSING FORCE INFORMATION

(71) Applicants: SHANGHAI FLEXIV ROBOTICS TECHNOLOGY CO., LTD., Shanghai (CN); FLEXIV LTD., Cayman Islands (GB)

(72) Inventors: Jinzhao CHANG, Santa Clara, CA (US); Yishun ZHOU, Santa Clara, CA (US); Hao JIANG, Santa Clara, CA (US)

(21) Appl. No.: 18/000,007

(22) PCT Filed: Aug. 5, 2022
(86) PCT No.: PCT/CN2022/110400

§ 371 Date: Nov. 28, 2022

(51) Int. Cl. B25J 15/02; B25J 9/16; B25J 13/08

(52) U.S. Cl. CPC B25J 15/0266; B25J 9/1612; B25J 13/082

(57) ABSTRACT

A gripping device, a robot and a method for sensing force information. The device includes a case, linkage gripping assemblies mutually matched to grip an object, a driving assembly and a plurality of load cells. Each linkage gripping assembly includes a fingertip, a first link fixedly connected to the fingertip, a second link including a first end rotatably connected to a first end of the first link and a second end rotatably connected to the case, and a third link including a first end rotatably connected to a second end of the first link and a second end rotatably connected to the case. The driving assembly is in transmission connection with the second end of the second link to rotate the second link. Each load cell is disposed in a respective one of at least three of the first link, the second link, the third link and the driving assembly.

### TECHNICAL FIELD

The present disclosure generally relates to the robotics field, and in particular to a gripping device, a robot including the gripping device, and a method for sensing force information of the gripping device.

### BACKGROUND

A gripping device is an important end effector of a robot. The gripping device is generally driven by a driving assembly and configured to grasp or release an object by using fingertips of the gripping device. When the gripping device is to grasp an object, especially a fragile object, it is desired to maintain a suitable and stable force applied by the fingertip on the object, and thus it is vital to monitor force information output by the fingertip on the object.

### SUMMARY

According to a first aspect of the present disclosure, some embodiments provide a gripping device including a case, a plurality of linkage gripping assemblies, a driving assembly and a plurality of load cells. The plurality of linkage gripping assemblies are mutually matched to grip an object, and each of the plurality of linkage gripping assemblies includes a fingertip, a first link, a second link and a third link. The fingertip is configured to grip the object, the first link is fixedly connected to the fingertip, a first end of the second link is rotatably connected to a first end of the first link and a second end of the second link is rotatably connected to the case, and a first end of the third link is rotatably connected to a second end of the first link and a second end of the third link is rotatably connected to the case. The driving assembly is in transmission connection with the second end of the second link and configured to rotate the second link. Each of the plurality of load cells is disposed in a respective one of at least three of the first link, the second link, the third link and the driving assembly, and is configured to measure an axial force of the respective one of at least three of the first link, the second link, the third link and the driving assembly of the gripping device in static equilibrium, for computing force information output by the fingertip.

According to a second aspect of the present disclosure, some embodiments further provide a robot including the above gripping device, a position measuring device and a control system. The position measuring device is configured to measure structural parameters and position parameters of each of the first link, the second link and the third link. The structural parameters include a length of each of the first link, the second link and the third link. The position parameters include an attitude vector of each of the first link, the second link and the third link. The control system is configured to acquire measurements of the position measuring device and measured values of the plurality of load cells responsive to the gripping device being in static equilibrium, to establish a static model of each of the first link, the second link, the third link and the driving assembly, and to compute force information output by the fingertip.

According to a third aspect of the present disclosure, some embodiments further provide a method for sensing force information. The method is applied to the above gripping device and includes: obtaining force measurements of the plurality of load cells responsive to the gripping device being in static equilibrium; measuring structural parameters and positional parameters of the first link, the second link and the third link; and establishing a static model of each of the first link, the second link, the third link and the driving assembly based on the force measurements, the structural parameters and the positional parameters, and computing force information output by the fingertip.

Details of one or more embodiments of the disclosure are set forth in the accompanying drawings and the description below. Other features, objects and advantages of the present disclosure will become apparent from the description, drawings and claims.

### BRIEF DESCRIPTION OF THE DRAWINGS

In order to illustrate technical solutions of the embodiments of the present disclosure more clearly, the following briefly introduces the accompanying drawings used in the description of the embodiments. The accompanying drawings in the following description are merely some exemplary embodiments of the present disclosure, but shall not be construed as a limitation to the protection scope of the disclosure.

FIG. 1 is a schematic structural diagram of a gripping device according to an exemplary embodiment of the present disclosure.

FIG. 2 is a schematic diagram of a link model of the gripping device shown in FIG. 1.

FIG. 3 is a force-body diagram of a first link and a fingertip of the gripping device shown in FIG. 2.

FIG. 4 is a force-body diagram of a second link of the gripping device shown in FIG. 2.

FIG. 5 is a force-body diagram of a third link of the gripping device shown in FIG. 2.

FIG. 6 is a moment diagram of a fourth link and a second link of the gripping device shown in FIG. 2.

FIG. 7 is a schematic structural diagram of a gripping device according to an embodiment of the present disclosure.

FIG. 8 is a schematic diagram of a link of the gripping device according to an embodiment of the present disclosure, showing that a load cell is embedded in the link.

FIG. 9 is a schematic diagram of a robot according to an embodiment of the present disclosure.

FIG. 10 is a schematic flowchart of a method for sensing force information of the gripping device according to an embodiment of the present disclosure.

### DETAILED DESCRIPTION

In order to make the above objects, features and advantages of the present disclosure more clearly understood, the specific embodiments of the present disclosure are described in detail below with reference to the accompanying drawings. In the following description, numerous specific details are set forth to provide thorough understanding of the present disclosure. However, the present disclosure may be implemented in various ways different from those described herein, and those skilled in the art may make similar improvements without violating the connotation of the present disclosure. Therefore, the present disclosure is not limited to the specific embodiments disclosed below.

In the description of the present disclosure, it should be understood that orientations or positional relationships indicated by terms such as “center”, “longitudinal”, “lateral”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, “axial”, “radial”, “circumferential” and others are based on the orientations or positional relationships shown in the accompanying drawings, and are merely for the convenience of describing the present disclosure and simplifying the description, rather than indicating or implying that the device or element referred to must have a specific orientation, be constructed and operate in a specific orientation, and therefore should not be deemed as a limitation of the present disclosure.

In the present disclosure, unless otherwise expressly specified and limited, terms such as “installation”, “link”, “connection”, “fixation”, “arrangement” and the like should be interpreted in a broad sense. For example, unless otherwise expressly defined, a “connection” may be a fixed connection, a detachable connection, or formed integrally; it may be a mechanical connection or an electrical connection; it may be a direct connection or an indirect connection through an intermediate medium. The connection may be an internal communication of the two elements or an interaction relationship of the two elements. As another example, when an element is referred to as being “fixed to” or “disposed to” another element, it may be directly on the other element or intervening elements may also be present. For those skilled in the art, the specific meanings of the above terms in the present disclosure may be understood according to specific situations.

The inventors noted that, in the field of robot's gripping device, there are generally two measurement methods to obtain a value of a force applied by a fingertip of the gripping device on an object responsive to the gripping device gripping the object.

In a first method, the gripping device is directly provided with a tactile sensor on a fingertip. Responsive to the fingertip gripping an object, the force applied by the fingertip on the object may be directly measured by the tactile sensor. However, a conventional tactile sensor may still fail to obtain reliable and accurate multi-degree of freedom (multi-DOF) force feedback information, as a result, this method is not widely applicable in the related field.

In a second method, considering that the gripping device is generally driven by a motor, and a driving torque of the motor is related to motor current, the torque information may be obtained by monitoring the motor current of the gripping device. However, the motor current is susceptible to external noise and thus may not be able to give accurate torque information. In addition, the torque information is merely one component of the multi-DOF force feedback information of the gripping device, and cannot reflect the multi-DOF force applied by the gripping device on the object.

However, as the gripping device of the robot is increasingly used to perform complex grasping tasks, especially to grasp a fragile object, it is vital to monitor and maintain a stable and accurate gripping force applied by the fingertips of the gripping device.

The present disclosure proposes to improve the related technologies by computing an output force of the fingertips of the gripping device based on a force and/or a moment equilibrium principle of the gripping device in static equilibrium.

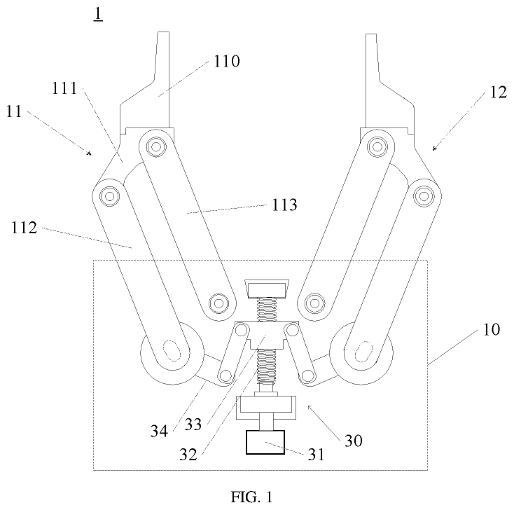

Herein, an inventive concept of the present disclosure is described with reference to an exemplary gripping device shown in FIG. 1.

Referring to FIG. 1, the exemplary gripping device 1 includes a case 10, a first quadrilateral linkage gripping assembly 11 and a second quadrilateral linkage gripping assembly 12 both mounted to the case 10, and a driving assembly 30. The first quadrilateral linkage gripping assembly 11 and the second quadrilateral linkage gripping assembly 12 are similar in structure and symmetrically arranged. The driving assembly 30 is configured to drive the first quadrilateral linkage gripping assembly 11 and the second quadrilateral linkage gripping assembly 12 respectively, to cause the gripping device 1 to grasp or release a target object.

Taking the first quadrilateral linkage gripping assembly 11 as an example for illustration, the first quadrilateral linkage gripping assembly 11 includes a fingertip 110, a first link 111, a second link 112 and a third link 113. The first link 111 is fixedly connected to the fingertip 110, and the second link 112 and the third 113 are connected to the first link 111 respectively. A first end of the second link 112 is rotatably connected to a first end of the first link 111, and a second end of the second link 112 is rotatably connected to the case 10. A first end of the third link 113 is rotatably connected to a second end of the first link 111, and a second end of the third link 113 is rotatably connected to the case 10. The driving assembly 30 may include a motor 31, a lead screw 32, a nut 33 and a transmission member 34. One end of the transmission member 34 is rotatably connected to the nut 33, and the other end of the transmission member 34 is fixedly connected to the second end of the second link 112. In this configuration, responsive to rotation of the lead screw 32, the nut 33 is driven to move along the lead screw 32, and further drives rotation of the second link 112 through the transmission member 34, thereby driving movements of the first link 111 and the third link 113. In other words, the motor 31 outputs a driving force in an axial direction of the lead screw 32, and drives the first link 111, the second link 112 and the third link 113 to move through the transmission member 34, thereby realizing the movement of the fingertip 110. It should be understood that in other embodiments, the driving assembly 30 may drive the third link 113 to move, to enable the first link 111 and the second link 112 to follow the movement of the third link 113. In this case, the proposed method for sensing force information in this disclosure is also applicable, although the calculation process is slightly different.

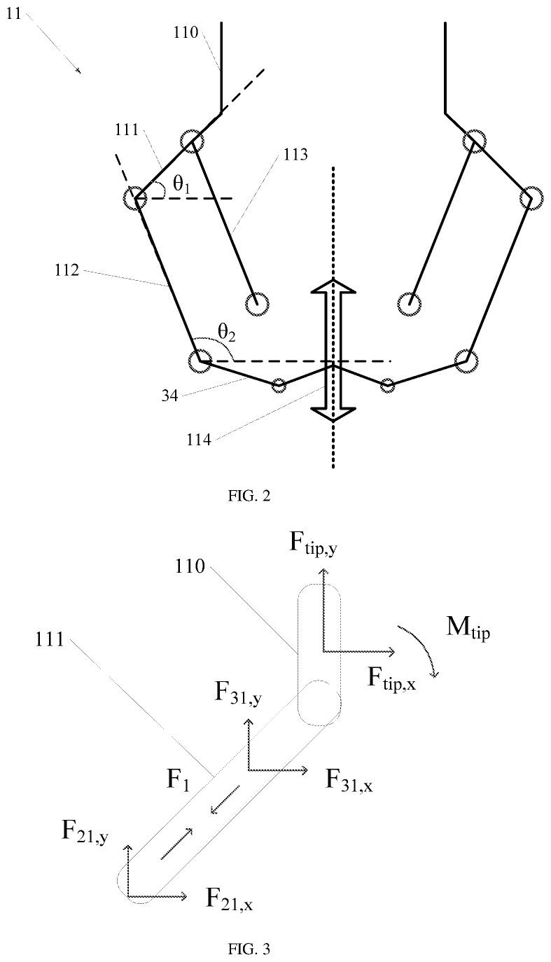

FIG. 2 is a schematic diagram of a link model of the gripping device 1 as shown in FIG. 1. Taking the first quadrilateral linkage gripping assembly 11 as an example for illustration, FIG. 2 illustrates the fingertip 110, the first link 111 fixedly connected to the fingertip 110, the second link 112 and the third link 113 in parallel, and a fourth link 114 equivalent to a driving force of the driving assembly in an axial direction of the lead screw. The fourth link 114 is connected to the second link 112 through the transmission member 34, to apply a torque on the second link 112.

The present disclosure is applicable to the gripping device 1 grasping an object and the gripping device 1 being in static equilibrium. Referring to FIGS. 3 to 6, force analysis of each of the fingertip 110, the first link 111, the second link 112, the third link 113 and the fourth link 114 in static equilibrium are illustrated.

FIG. 3 shows a force-body diagram of the fingertip 110 and the first link 111 of the gripping device 1. The fingertip 110 is fixedly connected to the first link 111, and the fingertip 110 and the first link 111 as a whole is taken as a research object. When the fingertip 110 and the first link 111 are in static equilibrium, force/moment equilibrium equations of a coplanar force system thereof are:

$${F}_{21 , x} + {F}_{31 , x} + {F}_{tip , x} = 0 \qquad ( 1 )$$

$${F}_{21 , y} + {F}_{31 , y} + {F}_{tip , y} = 0 \qquad ( 2 )$$

$${M}_{t i p} + {F}_{31 , x} ( {l}_{tip} + Δ {l}_{1} sin {θ}_{1} ) - {F}_{31 , y} ( Δ {l}_{1} cos {θ}_{1} ) + {F}_{21 , x} ( {l}_{tip} + {l}_{1} sin {θ}_{1} ) - {F}_{21 , y} ( {l}_{1} cos {θ}_{1} ) = 0 \qquad ( 3 )$$

$${F}_{21 , x} cos {θ}_{1} + {F}_{21 , y} sin {θ}_{1} = {F}_{1} \qquad ( 4 )$$

Wherein, F_{21,x} is a horizontal component force of the second link 112 on the first link 111, F_{21,y} is a vertical component force of the second link 112 on the first link 111, and F_{31,x} is a horizontal component force of the third link 113 on the first link 111, F_{31,y} is a vertical component force of the third link 113 on the first link 111, F_{tip,x} is a normal force of the fingertip 110 on the object, F_{tip,y} is a tangential force of the fingertip 110 on the object, Mₜᵢₚ is a bending moment of the fingertip 110, F₁ is an axial force of the first link 111, lₜᵢₚ is a length of the fingertip 110, Δl₁ is a length of a connecting line from a connection point of the first link 111 and the third link 113 to a connection point of the first link 111 and the fingertip 110, l₁ is a length of the first link 111, and θ₁ is an included angle between a length direction of the first link 111 and a horizontal direction.

That is, in the above force analysis on the first link 111 and the fingertip 110, there are totally 4 equations and 9 unknown quantities, i.e., F_{21,x}, F_{21,y}, F_{31,x}, F_{31,y}, F F_{tip,y}, Mₜᵢₚ, F₁, θ₁. In the above equations, lₜᵢₚ is a structural parameter of the fingertip 110, l₁ is a structural parameter of the first link 111, Δl₁ is related to structural parameters of the first link 111 and the third link 113. As a result, lₜᵢₚ, l₁ and Δl₁ may be regarded as known quantities.

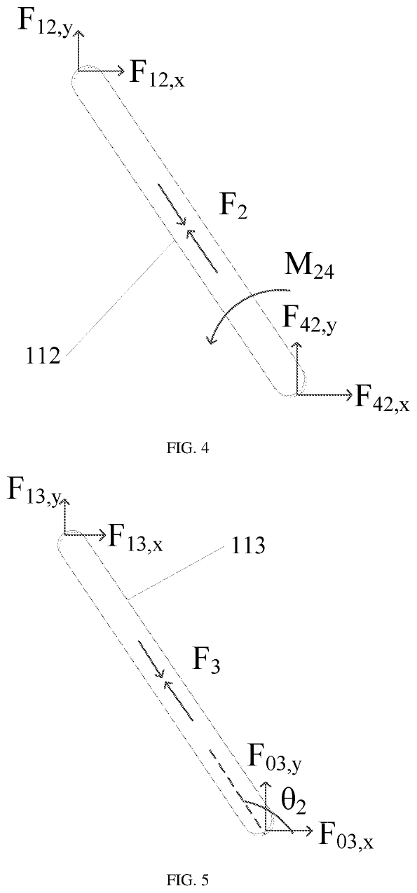

FIG. 4 shows a force-body diagram of the second link 112 of the gripping device 1. Taking the second link 112 as a research object, since the second link 112 is in static equilibrium, force/moment equilibrium equations of a planar force system thereof are:

$${F}_{12 , x} + {F}_{42 , x} = 0 \qquad ( 5 )$$

$${F}_{12 , y} + {F}_{42 , y} = 0 \qquad ( 6 )$$

$${M}_{24} + {F}_{12 , y} {l}_{2} cos {θ}_{2} - {F}_{12 , x} {l}_{2} sin {θ}_{2} = 0 \qquad ( 7 )$$

$${F}_{12 , x} cos {θ}_{2} - {F}_{12 , y} sin {θ}_{2} = {F}_{2} \qquad ( 8 )$$

Wherein, F_{12,x} is a horizontal component force of the first link 111 on the second link 112, F_{42,x} is a horizontal component force of the fourth link 114 on the second link 112, F_{12,y} is a vertical component force of the first link 111 on the second link 112, F_{42,y} is a vertical component force of the fourth link 114 on the second link 112, M₂₄ is a rotational moment of the second link 112, l₂ is a length of the second link 112, θ₂ is an included angle between a length direction of the second link 112 and a horizontal direction, and F₂ is an axial force of the second link member 112.

In the above equations, F_{12,x} and F_{21,x} are equal in magnitude and opposite in direction; F_{12,y} and F_{21,y} are equal in magnitude and opposite in direction.

That is, in the force analysis of the second member 112, there are totally 4 equations and 4 unknown quantities, i.e., F_{42,x}, F_{42,y}, θ₂, F₂. In the above equations, l₂ is a structural parameter of the second link 112, so l₂ can be regarded as a known quantity.

Referring to FIG. 5, which shows a force-body diagram of the third link 113 of the gripping device 1. Taking the third link 113 as a research object, since the third link 113 is in static equilibrium, force/moment equilibrium equations of a planar force system thereof are:

$${F}_{13 , x} + {F}_{03 , x} = 0 \qquad ( 9 )$$

$${F}_{13 , y} + {F}_{03 , y} = 0 \qquad ( 10 )$$

$$tan {θ}_{2} = \frac{{F}_{03 , y}}{{F}_{03 , x}} \qquad ( 11 )$$

$${F}_{13 , x} = {F}_{3} cos {θ}_{2} \qquad ( 12 )$$

$${F}_{13 , y} = {F}_{3} sin {θ}_{2} \qquad ( 13 )$$

Wherein, F_{13,x} is a horizontal component force of the first link 111 on the third link 113, F_{03,x} is a horizontal component force of the case 10 on the third link 113, F_{13,y} is a vertical component force of the first link 111 on the third link 113, F_{03,y} is a vertical component force of the case 10 on the third link 113, and F₃ is an axial force of the second link 112.

In the above equations, F_{13,x} and the above F_{31,x} are equal in magnitude and opposite in direction; F_{13,y} and the above F_{31,y} are equal in magnitude and opposite in direction.

That is, in the force analysis of the third member 113, there are totally 5 equations and 3 unknown quantities, i.e., F_{03,x}, F_{03,y}, F₃.

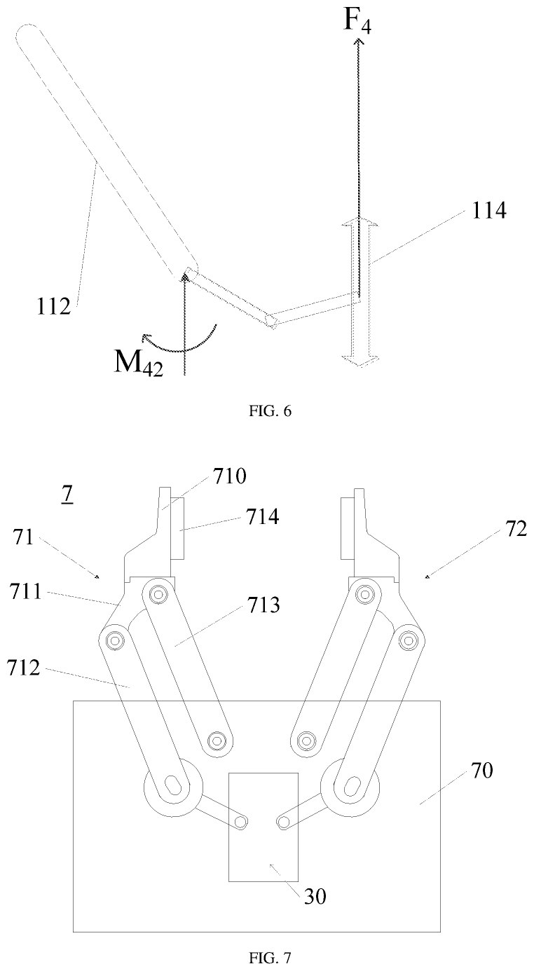

Referring to FIG. 6, which shows a moment diagram of the fourth link 114 and the second link 112 of the gripping device 1, the fourth link 114 is taken as a research object, since the driving assembly 30 is in static equilibrium, a moment equation of a planar force system thereof is:

$${M}_{42} = {F}_{4} {l}_{4} \qquad ( 14 )$$

Wherein, M₄₂ is a moment of the fourth link 114 on the second link 112, l₄ is a vertical distance from a connection point of the second link 112 and the transmission member 34 to an extending direction of the fourth link 114, and F₄ is an axial driving force of the fourth link 114. M₄₂ and the above M₂₄ are equal in magnitude and opposite in direction.

That is, in the force analysis of the fourth member 114, there is totally 1 equation and 1 unknown quantity, i.e., F₄. In the above equation, l₄ is a structural parameter of the second link 112 and the fourth link 114, so l₄ can be regarded as a known quantity.

To sum up, when the gripping device 1 is in static equilibrium, the force/moment equilibrium equations of planar force systems of equivalent four links involve totally 18 unknown quantities and 14 equations. In the 18 unknown quantities, the included angles θ₁ and θ₂ are related to positions and attitudes of the first link 111, the second link 112 and the third link 113 in static equilibrium, and thus the θ₁ and θ₂ may be determined by a position encoder of the motor 31 and an attitude measuring device of the link. Thereby, the above equations (1)-(14) include a total of 16 unknown quantities. In theory, it is enough to measure 2 unknown quantities to reduce the unknown quantities to 14. However, considering that two equations in the force analysis of the third member 113 use the parameter F₃, it is required to measure 3 unknown quantities to reduce the unknown quantities to 13, so that through solving the 14 equations, output force information, e.g., a normal force F_{tip,x}, a tangential force F_{tip,y} and a bending moment Mₜᵢₚ of the fingertip 110 can be obtained.

Based on the above inventive concept, some embodiments of the present disclosure propose to provide a gripping device 1, where the normal force F_{tip,x}, the tangential force F_{tip,y} and the bending moment Mₜᵢₚ output by the fingertip 110 can be computed according to the above equations (1)-(14), by measuring axial force values of any three of the first link 111, the second link 112, the third link 113 and the fourth link 114, i.e., any three of axial force values of F₁, F₂, F₃, F₄.

In order to realize the above inventive concept, some embodiments of the present disclosure provide a gripping device, which includes a case and a plurality of linkage gripping assemblies mutually matched to grip an object. Each of the plurality of linkage gripping assemblies includes a fingertip configured to grip an object, a first link, a second link, a third link and a driving assembly. The first link is fixedly connected to the fingertip. A first end of the second link is rotatably connected to a first end of the first link, and a second end of the second link is rotatably connected to the case. A first end of the third link is rotatably connected to a second end of the first link, and a second end of the third link is rotatably connected to the case. The gripping device further includes a driving assembly, which is in transmission connection with the second end of the second link to rotate the second link. Each of the plurality of linkage gripping assemblies further includes a plurality of load cells. Each of the plurality of load cells is disposed in a respective one of at least three of the first link, the second link, the third link and the driving assembly, and is configured to measure an axial force of the respective one of at least three of the first link, the second link, the third link and the driving assembly of the gripping device in static equilibrium, for computing force information output by the fingertip. The force information may include a tangential force exerted on a contact surface, a normal force, and a bending moment of the fingertip.

According to the embodiments of the present disclosure, when the fingertip of the gripping device grips the object and is in static equilibrium, output force information applied by the fingertip on the object can be computed according to the force and/or moment equilibrium principles, so as to monitor the multi-DOF force information applied by the gripping device on the object.

Referring to FIG. 7, some embodiments of the present disclosure provide a gripping device 7, which includes a case 70, a first linkage gripping assembly 71 and a second linkage gripping assembly 72 both mounted to the case 70. In other embodiments, the gripping device 7 may include more linkage gripping assemblies, e.g., three or more linkage gripping assemblies. Two or more linkage gripping assemblies of the gripping device 7 are mutually matched to grip a target object. In the present disclosure, for the convenience of description, as shown in FIG. 7, the gripping device 7 includes two linkage gripping assemblies (i.e., the first linkage gripping assembly 71 and the second linkage gripping assembly 72), and the two linkage gripping assemblies are similar in structure and symmetrically arranged.

Taking the first linkage gripping assembly 71 as an example for illustration, the first linkage gripping assembly 71 includes a fingertip 710, a first link 711 fixedly connected to the fingertip 710, a second link 712 and a third link 713 respectively connected to the first link 711. A first end of the second link 712 is rotatably connected to a first end of the first link 711, and a second end of the second link 712 is rotatably connected to the case 70. A first end of the third link 713 is rotatably connected to a second end of the first link 711, and a second end of the third link 713 is rotatably connected to the case 70.

In an example, a rotation center of the first end of the second link 712, a rotation center of the second end of the second link 712, a rotation center of the second end of the third link 713, and a rotation center of the first end of the third link 713 constitute four vertices of a quadrilateral in turn, thereby forming a four-link structure. In another example, at least the second link 712 and the third link 713 are arranged in parallel. In yet another example, the rotation center of the first end of the second link 712, the rotation center of the second end of the second link 712, the rotation center of the second end of the third link 713, and the rotation center of the first end of the third link 713 constitute four vertices of a parallelogram in turn, thereby forming a parallelogram linkage mechanism.

The gripping device 7 further includes a driving assembly 30 configured to output a driving force in an axial direction. The driving assembly is in transmission connection with the second end of a respective second link, to rotate the respective second link, thereby realizing relative movement between the first linkage gripping assembly 71 and the second linkage gripping assembly 72.

In combination with FIG. 1, in an example, the driving assembly 30 may include a motor 31, a lead screw 32, a nut 33 and a plurality of transmission members 34. The lead screw 32 is connected to an output end of the motor 31, so that the lead screw 32 may be driven by the motor 31 to rotate about the axial direction. The nut 33 is matched with the lead screw 32, and moves in the axial direction of the lead screw 32 responsive to the rotation of the lead screw 32. Each of the plurality of transmission members 34 is disposed corresponding to a respective one of the plurality of linkage gripping assemblies. A first end of a respective transmission member 34 is rotatably connected to the nut 33, and a second end of the respective transmission link 34 is fixedly connected to the second end of the link 712, such that the nut 33 rotates the second link 712 responsive to the motor 31 driving the lead screw 32 to rotate about the axial direction. Based on this, by using the motor 31, the driving assembly 30 may output the driving force in the axial direction of the lead screw 32.

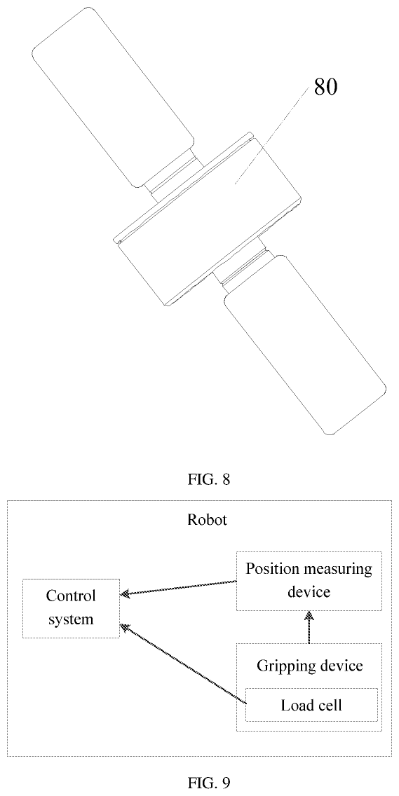

Referring to FIG. 8, which shows a schematic structural diagram of a link according to some embodiments of the present disclosure, the link is embedded with a load cell 80 in an axial direction to measure an axial force of the link. In some embodiments of the present disclosure, the link in FIG. 8 is applicable to the first link 711, the second link 712 or the third link 713 of the gripping device 7 to measure the axial force of a respective link. It can be understood that the axial force refers to an internal axial force of each of the first link 711, the second link 712 and the third link 713.

The driving assembly 30 of the gripping device 7 may also be provided with the load cell 80 for measuring a driving force axially output by the driving assembly 30. In an example, referring to FIGS. 1 and 8, the load cell may also be embedded in the lead screw 32 in the axial direction to measure the axial force of the lead screw of the gripping device 7 in static equilibrium. In other examples, the driving assembly 30 may be provided with a force measuring assembly in other ways to measure the drive force axially output by the driving assembly 30, e.g., including the way described in Chinese Patent Application CN112351869A, the entire contents of which are incorporated herein by reference.

The following describes specific examples that the load cell is disposed in a respective one of at least three of the first link 711, the second link 712, the third link 713 and the driving assembly 30 (the axial driving force of which is equivalent to the fourth link), to compute the output force information of the fingertip 710.

In a first example, each of the first link 711, the second link 712 and the third link 713 is provided with an axial force sensor. When the gripping device 7 is in static equilibrium, the axial force sensor of the first link 711 obtains an axial force value F₁, the axial force sensor of the second link 712 obtains an axial force value F₂, and the axial force sensor of the third link 713 obtains an axial force value F₃. The above 14 force/moment equilibrium equations may be transformed into a following matrix equation, to solve the normal force F_{tip,x}, the tangential force F_{tip,y} and the bending moment Mₜᵢₚ output by the fingertip 710.

$$( \begin{matrix}{F}_{tip , x} \\ {F}_{tip , y} \\ {M}_{tip}\end{matrix} ) = M \times ( \begin{matrix}{F}_{2} \\ {F}_{1} \\ {F}_{3}\end{matrix} )$$

$$M = \frac{1}{- sin ( {θ}_{2} - {θ}_{1} )} ( \begin{matrix}- sin {θ}_{1} & sin {θ}_{2} & {cos}^{2} {θ}_{2} sin {θ}_{1} - cos {θ}_{2} cos {θ}_{1} sin {θ}_{2} \\ cos {θ}_{1} & cos {θ}_{2} & sin {θ}_{2} cos {θ}_{2} sin {θ}_{1} - {sin}^{2} {θ}_{2} cos {θ}_{1} \\ \begin{matrix}- ( {l}_{1} + \\ {l}_{tip} sin {θ}_{1} )\end{matrix} & \begin{matrix}{l}_{1} cos ( {θ}_{2} - {θ}_{1} ) + \\ {l}_{tip} sin {θ}_{2}\end{matrix} & \begin{matrix}\frac{1}{2} ( - cos ( 2 {θ}_{2} - 2 {θ}_{1} ) + 1 ) \times \\ Δ {l}_{1} - {l}_{tip} cos {θ}_{2} sin ( {θ}_{2} - {θ}_{1} )\end{matrix}\end{matrix} )$$

In a second example, each of the second link 712, the third link 713 and the driving assembly 30 is provided with an axial force sensor. When the gripping device 7 is in static equilibrium, the axial force sensor of the second link 712 obtains an axial force value F₂, the axial force sensor of the third link 713 obtains an axial force value F₃, and the axial force sensor of the driving assembly 30 obtains an axial force value F₄. Similarly, the normal force F_{tip,x}, the tangential force F_{tip,y} and the bending moment Mₜᵢₚ output by the fingertip 710 can be solved by using the above 14 force/moment equilibrium equations.

In a third example, each of the first link 711, the third link 713 and the driving assembly 30 is provided with an axial force sensor. When the gripping device 7 is in static equilibrium, the axial force sensor of the first link 711 obtains an axial force value F₁, the axial force sensor of the third link 713 obtains an axial force value F₃, and the axial force sensor of the driving assembly 30 obtains an axial force value F₄. Similarly, the normal force F_{tip,x}, the tangential force F_{tip,y} and the bending moment Mₜᵢₚ output by the fingertip 710 can be solved by using the above 14 force/moment equilibrium equations.

In a fourth example, each of the first link 711, the second link 712 and the driving assembly 30 is provided with an axial force sensor. When the gripping device 7 is in static equilibrium, the axial force sensor of the first link 711 obtains an axial force value F₁, the axial force sensor of the second link 712 obtains an axial force value F₂, and the axial force sensor of the driving assembly 30 obtains an axial force value F₄. Similarly, the normal force F_{tip,x}, the tangential force F_{tip,y} and the bending moment Mₜᵢₚ output by the fingertip 710 can be solved by using the above 14 force/moment equilibrium equations.

Considering that in the above force/moment equilibrium equations for the third link 713, both equations (12) and (13) involve F₃, therefore, in a further embodiment, the third link 713 is provided with an axial force sensor, at least two of the first link 711, the second link 712 and the driving assembly 30 are provided with axial force sensors respectively. When the gripping device 7 is in static equilibrium, force/moment equilibrium equations are established based on a static model, and the force values of the plurality of axial force sensors are substituted into the force/moment equilibrium equations, so as to solve the normal force F_{tip,x}, the tangential force F_{tip,y} and the bending moment Mₜᵢₚ output by the fingertip 710.

The gripping device 7 may be further provided with a multi-DOF sensor 714. Referring to FIG. 7, the multi-DOF sensor 714 may be arranged on the fingertip 710 to directly measure the output force of the fingertip 710. Based on this, in addition to the normal force F_{tip,x}, the tangential force F_{tip,y} and the bending moment of Mₜᵢₚ of the fingertip 710 obtained by using the static model of the gripping device 7, other DOF forces of the fingertip 710 may be obtained by the multi-DOF sensor 714, which is beneficial for monitoring output forces of other DOF of the fingertip 710.

Based on a same technical concept, referring to FIG. 9, some embodiments of the present disclosure further provide a robot, including the gripping device 7 in any of the above embodiments, a position measuring device and a control system. The position measuring device is configured to measure structural parameters and position parameters of the first link 711, the second link 712 and the third link 713. The structural parameters include a length of each of the first link 711, the second link 712 and the third link 713, and the position parameters include an attitude vector of each of the first link 711, the second link 712 and the third link 713. The control system is configured to obtain measurements of the position measuring device and the plurality of load cells when the gripping device 7 is in static equilibrium, to establish static models of the first link 711, the second link 712, the third link 713 and the driving assembly 30 respectively, and to compute force information output by the fingertip 710.

In one example, based on the above force/moment equilibrium equations (1) to (14), the gripping device 7 is provided with at least three load cells to obtain at least three of an axial force value F₁ of the first link 711 and an axial force value F₂ of the second link 712, an axial force value F₃ of the third link 713 and an axial force value F₄ of the driving assembly 30. The position measuring device is configured to measure the structural parameters and position parameters of the first link 711, the second link 712 and the third link 713 to obtain included angles parameters θ₁, θ₂, length parameters lₜᵢₚ, l₁, l₂, l₄ and Ali, etc. When the gripping device 7 is in static equilibrium, the control system establishes force/moment equilibrium equations for each link of the gripping device 7, obtains measurements of the plurality of load cells and the position measuring device, and solves the normal force F_{tip,x}, the tangential force F_{tip,y} and the bending moment Mₜᵢₚ of the fingertip 710.

It can be understood that for other structural details of the robot in this embodiment, reference may be made to the relevant description of the above embodiments of the gripping device 7, which will not be repeated herein.

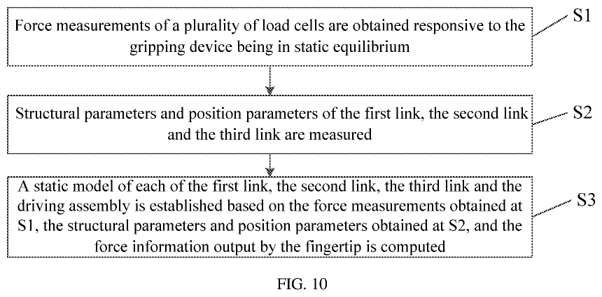

Based on a same technical concept, some embodiments of the present disclosure further provide a method for sensing force information, which may be applied to any of the above-mentioned gripping devices 7 and robots. Referring to FIG. 10, the method for sensing force information includes the following steps S1 to S3.

At Step S1, force measurements of a plurality of load cells are obtained responsive to the gripping device being in static equilibrium.

In an example, the gripping device 7 is provided with at least three load cells. When the gripping device 7 is in static equilibrium, at least three of the axial force value F₁ of the first link 711, the axial force value F₂ of the second link 712, the axial force value F₃ of the third link 713 and the axial force value F₄ of the fourth link are obtained based on the at least three load cells.

At Step S2, structural parameters and position parameters of the first link, the second link and the third link are measured.

In an example, when the gripping device 7 is in static equilibrium, according to an position and an attitude of the linkage gripping assembly of the gripping device 7, one can obtain parameters such as an included angle θ1 between a length direction of the first link 711 and a horizontal direction, an included angle θ₂ between a length direction of the link 712 and a horizontal direction, a length l₁ of the first link 711, a length l₂ of the second link 712, a length Δl₁ from a connection point of the first link 711 and the third link 713 to a connection point of the first link 711 and the fingertip 710, and a vertical distance l₄ from a connecting point of the second link 712 and the transmission member relative to an axial extending direction of the driving assembly 30.

At Step S3, a static model of each of the first link, the second link, the third link and the driving assembly is established based on the force measurements obtained at Step S1, the structural parameters and position parameters obtained at Step S2, and the force information output by the fingertip is computed.

In an example, when the gripping device 7 is in static equilibrium, each of the first link 711, the second link 712 and the third link 713 is simplified as a two-force member, and an integration of the driving assembly 30 and the second link 712 is simplified as a moment model, and a static force analysis is performed on each of the two-force members and the moment model, and the force/moment equilibrium equations of the planar force system of the first link 711, the second link 712, the third link 713 and the driving assembly 30 are established respectively, to solve the normal force F_{tip,x}, the tangential force F_{tip,y} and the bending moment Mₜᵢₚ output by the fingertip 710.

It can be understood that for other implementation details of the method for sensing force information in this embodiment, reference may be made to the relevant descriptions of the above embodiments of the gripping device 7 and the robot, which will not be repeated herein.

In conclusion, according to the gripping device, the robot and the method for sensing force information provided by the embodiments of the present disclosure, the axial force sensor is disposed in the links and/or the driving assembly of the gripping device, so that when the gripping device is in static equilibrium, the force/moment equilibrium equations of the planar force system of the links and/or the driving assembly of the gripping device are established, thereby enabling to compute the output force information of the fingertip, and to monitor the multi-DOF force information output by the fingertip of the gripping device. In addition, by monitoring the multi-DOF force information applied by the fingertip on the object, it is beneficial for maintaining a stable and accurate gripping force applied by the gripping device on the object, so as to improve robustness and adaptability of the gripping device of the robot.

Those of ordinary skill in the art can understand that all or part of the processes in the methods of the above embodiments may be implemented by instructing relevant hardware through a computer program. The computer program can be stored in a non-transitory computer-readable storage medium, when the computer program is executed, to implement the processes of the above-mentioned method embodiments. Any reference to a memory, a storage, a database or other media used in the various embodiments provided in this disclosure may include at least one of a non-transitory memory and a transitory memory. The non-transitory memory may include a read-only memory (ROM), a magnetic tape, a floppy disk, a flash memory, or an optical memory or the like. The transitory memory may include a random access memory (RAM) or an external cache memory. By way of illustration and not limitation, the RAM may be in various forms, such as a static random access memory (SRAM) or a dynamic random access memory (DRAM).

The technical features of the above-described embodiments can be combined arbitrarily according to the actual situation. For the sake of brevity, not all possible combinations of the technical features are described in the above-described embodiments. However, as long as the combinations of these technical features do not constitute any contradiction, they shall fall within the scope of the description in this specification.

The above-mentioned embodiments merely represent several embodiments of the present disclosure, and the descriptions thereof are specific and detailed, but should not be construed as a limitation to the scope of the present disclosure. It should be noted that for those of ordinary skill in the art, some modifications and improvements may be made without departing from the concept of the present disclosure, which shall all fall within the protection scope of the present disclosure. Therefore, the protection scope of the disclosure shall be subject to the appended claims.

1-10. (canceled)

11. A gripping device, comprising:
a case;
a plurality of linkage gripping assemblies being mutually matched to grip an object, and each of the plurality of linkage gripping assemblies comprising:
a fingertip configured to grip the object;
a first link fixedly connected to the fingertip;
a second link, wherein a first end of the second link is rotatably connected to a first end of the first link and a second end of the second link is rotatably connected to the case; and
a third link, wherein a first end of the third link is rotatably connected to a second end of the first link and a second end of the third link is rotatably connected to the case;
a driving assembly being in transmission connection with the second end of the second link and configured to rotate the second link; and
a plurality of load cells, each of the plurality of load cells being disposed in a respective one of at least three of the first link, the second link, the third link and the driving assembly, and being configured to measure an axial force of the respective one of at least three of the first link, the second link, the third link and the driving assembly of the gripping device in static equilibrium, for computing force information output by the fingertip.

12. The gripping device according to claim 11, wherein at least the third link is embedded with one of the plurality of load cells in an axial direction to measure the axial force of the third link of the gripping device in static equilibrium, wherein the axial force includes an internal axial force of the third link.

13. The gripping device according to claim 11, wherein the driving assembly comprises:
a motor;
a lead screw connected to an output end of the motor, and configured to be driven to rotate about an axial direction by the motor;
a nut matched with the lead screw and configured to move in an axial direction of the lead screw responsive to rotation of the lead screw; and
a plurality of transmission members, each of the plurality of transmission members corresponding to a respective one of the plurality of linkage gripping assemblies, wherein a first end of each of the plurality of transmission members is rotatably connected to the nut, and a second end of each of the plurality of transmission members is fixedly connected to the second end of the second link, such that the nut rotates the second link responsive to the motor driving the lead screw to rotate about the axial direction.

14. The gripping device according to claim 13, wherein the driving assembly is provided with one of the plurality of load cells; and the load cell is configured to measure a driving force output by the driving assembly in the axial direction of the lead screw.

15. The gripping device according to claim 11, wherein each of the plurality of load cells is embedded in a respective one of the first link, the second link and the third link in an axial direction, and is configured to measure the axial force of a respective one of the first link, the second link and the third link of the gripping device in static equilibrium, wherein the axial force includes an internal axial force of each of the first link, the second link and the third link.

16. The gripping device according to claim 11, wherein the force information comprises a tangential force exerted on a contact surface, a normal force, and a bending moment of the fingertip.

17. The gripping device according to claim 11, wherein the fingertip is further provided with a multi-DOF sensor to measure force information of the fingertip responsive to the fingertip gripping the object.

18. The gripping device according to claim 11, wherein each of the plurality of linkage gripping assemblies is a quadrilateral linkage gripping assembly; the second link and the third link are arranged in parallel.

19. A robot, comprising:
a gripping device comprising:
a case;
a plurality of linkage gripping assemblies being mutually matched to grip an object, and each of the plurality of linkage gripping assemblies comprising:
a fingertip configured to grip the object;
a first link fixedly connected to the fingertip;
a second link, wherein a first end of the second link is rotatably connected to a first end of the first link and a second end of the second link is rotatably connected to the case; and
a third link, wherein a first end of the third link is rotatably connected to a second end of the first link and a second end of the third link is rotatably connected to the case;
a driving assembly being in transmission connection with the second end of the second link and configured to rotate the second link; and
a plurality of load cells, each of the plurality of load cells being disposed in a respective one of at least three of the first link, the second link, the third link and the driving assembly, and being configured to measure an axial force of the respective one of at least three of the first link, the second link, the third link and the driving assembly of the gripping device in static equilibrium, for computing force information output by the fingertip;
a position measuring device configured to measure structural parameters and position parameters of each of the first link, the second link and the third link; wherein the structural parameters comprise a length of each of the first link, the second link and the third link, the position parameters comprise an attitude vector of each of the first link, the second link and the third link; and
a control system configured to acquire measurements of the position measuring device and measured values of the plurality of load cells responsive to the gripping device being in static equilibrium, to establish a static model of each of the first link, the second link, the third link and the driving assembly, and to compute the force information output by the fingertip.

20. The robot according to claim 19, wherein at least the third link is embedded with one of the plurality of load cells in an axial direction to measure the axial force of the third link of the gripping device in static equilibrium, wherein the axial force includes an internal axial force of the third link.

21. The robot according to claim 19, wherein the driving assembly comprises:
a motor;
a lead screw connected to an output end of the motor, and configured to be driven to rotate about an axial direction by the motor;
a nut matched with the lead screw and configured to move in an axial direction of the lead screw responsive to rotation of the lead screw; and
a plurality of transmission members, each of the plurality of transmission members corresponding to a respective one of the plurality of linkage gripping assemblies, wherein a first end of each of the plurality of transmission members is rotatably connected to the nut, and a second end of each of the plurality of transmission members is fixedly connected to the second end of the second link, such that the nut rotates the second link responsive to the motor driving the lead screw to rotate about the axial direction.

22. The robot according to claim 21, wherein the driving assembly is provided with one of the plurality of load cells; and the load cell is configured to measure a driving force output by the driving assembly in the axial direction of the lead screw.

23. The robot according to claim 19, wherein each of the plurality of load cells is embedded in a respective one of the first link, the second link and the third link in an axial direction, and is configured to measure the axial force of a respective one of the first link, the second link and the third link of the gripping device in static equilibrium, wherein the axial force includes an internal axial force of each of the first link, the second link and the third link.

24. The robot according to claim 19, wherein the force information comprises a tangential force exerted on a contact surface, a normal force, and a bending moment of the fingertip.

25. The robot according to claim 19, wherein the fingertip is further provided with a multi-DOF sensor to measure force information of the fingertip responsive to the fingertip gripping the object.

26. A method for sensing force information, applied to a gripping device comprising:
a case;
a plurality of linkage gripping assemblies being mutually matched to grip an object, and each of the plurality of linkage gripping assemblies comprising:
a fingertip configured to grip the object;
a first link fixedly connected to the fingertip;
a second link, wherein a first end of the second link is rotatably connected to a first end of the first link and a second end of the second link is rotatably connected to the case; and
a third link, wherein a first end of the third link is rotatably connected to a second end of the first link and a second end of the third link is rotatably connected to the case;
a driving assembly being in transmission connection with the second end of the second link and configured to rotate the second link; and
a plurality of load cells, each of the plurality of load cells being disposed in a respective one of at least three of the first link, the second link, the third link and the driving assembly, and being configured to measure an axial force of the respective one of at least three of the first link, the second link, the third link and the driving assembly of the gripping device in static equilibrium, for computing force information output by the fingertip;
the method comprising:
obtaining force measurements of the plurality of load cells responsive to the gripping device being in static equilibrium;
measuring structural parameters and positional parameters of the first link, the second link and the third link; and
establishing a static model of each of the first link, the second link, the third link and the driving assembly based on the force measurements, the structural parameters and the positional parameters, and computing the force information output by the fingertip.

27. The method according to claim 26, wherein the establishing the static model of each of the first link, the second link, the third link and the driving assembly based on the force measurements, the structural parameters and the positional parameters comprises:
simplifying each of the first link, the second link and the third link as a two-force member, and simplifying an integration of the driving assembly and the second link as a moment equilibrium model;
performing a static force analysis on the two-force member and the moment equilibrium model; and
establishing a static model of each of the first link, the second link, the third link and the driving assembly.

28. The method according to claim 26, wherein the obtaining force measurements of the plurality of load cells responsive to the gripping device being in static equilibrium comprises:
responsive to the gripping device being in static equilibrium, obtaining at least three of the axial force of the first link, the axial force of the second link, the axial force of the third link and the axial force of the fourth link based on the at least three load cells.

29. The method according to claim 26, wherein the structural parameters and positional parameters of the first link, the second link and the third link comprises at least one of:
an included angle between a length direction of the first link and a horizontal direction;
an included angle between a length direction of the second link and the horizontal direction;
a length of the first link;
a length of the second link;
a length from a connection point of the first link and the third link to a connection point of the first link and the fingertip; or
a vertical distance from a connecting point of the second link and the transmission member relative to an axial extending direction of the driving assembly.

30. The method according to claim 26, wherein the force information output by the fingertip comprises at least one of a normal force, a tangential force, or a bending moment output by the fingertip.
